(19) United States
(12) Patent Application Publication
(10) Pub. No.: US 2010/0149428 A1
(43) Pub. Date: Jun. 17, 2010

(54) Backlight Device, Display Device, and Television Receiver

(76) Inventor: Ryuhei Kishimoto, Mie (JP)

Correspondence Address: HARNESS, DICKEY & PIERCE, P.L.C., P.O. BOX 8910, RESTON, VA, 20195, US

(21) Appl. No.: 12/087,883

(22) PCT Filed: Sep. 14, 2006
(86) PCT No.: PCT/JP2006/318235

§ 371 Date: Jul. 16, 2008

(30) Foreign Application Priority Data
Feb. 10, 2006 (JP) 2006-034244

(51) Int. Cl. H04N 5/44; H05B 41/36; H04N 5/66

(52) U.S. Cl. 348/725; 315/287; 348/E05.096; 348/739; 348/E05.133

(57) ABSTRACT

In one embodiment of the present invention, a backlight device includes six light source units including cold-cathode tubes (linear light sources) and driving circuits for driving the respective cold-cathode tubes. The light source units are arranged in a direction perpendicular to a longitudinal direction of the cold-cathode tubes. In one embodiment of the backlight device, an inverter controller (control portion) turns on the cold-cathode tubes included in each of two light source units that are adjacent in the direction perpendicular to the longitudinal direction while phases of on-time/off-time cycles of PWM dimming of the two adjacent light source units are shifted from each other.

### TECHNICAL FIELD

The present invention relates to a backlight device including a plurality of linear light sources, and a display device and a television receiver that use the backlight device.

### BACKGROUND ART

In recent years, a display device that includes a liquid crystal panel as a flat display portion and has many advantages such as thinness and light weight over conventional cathode-ray tubes, as typified by a liquid crystal display device, has been becoming the mainstream of home television receivers. Such a liquid crystal display device includes a backlight device and a liquid crystal panel. The backlight device emits light, and the liquid crystal panel displays desired images by functioning as a shatter with respect to light from a light source provided in the backlight device. The television receiver is configured to display information such as characters and images included in the video signals of a television broadcast on the display surface of the liquid crystal panel.

Furthermore, the above backlight device is classified roughly into a direct type and an edge-light type depending upon the arrangement of the light source with respect to the liquid crystal panel. In the liquid crystal display device including a liquid crystal panel of 20 inches or more, the direct type backlight device is used generally because it can facilitate an increase in brightness and size compared with the edge-light type. More specifically, the direct type backlight device has a configuration in which a plurality of cold-cathode tubes are disposed on a back (non-display surface) side of the liquid crystal panel as linear light sources, and the cold-cathode tubes can be disposed immediately on a reverse side of the liquid crystal panel, which enables a number of cold-cathode tubes to be used. Thus, the direct type backlight device is likely to have high brightness and suitable for increasing the brightness and the size. Furthermore, the direct type backlight device has a hollow structure and therefore is light-weight even if it is enlarged. In this regard, the direct type backlight device is suitable for increasing the brightness and the size.

In a conventional backlight device, as described in JP 2000-292767 A for example, it has been proposed that the amount of incident light from the light-emitting surface to the liquid crystal panel is adjusted by turning on the cold-cathode tubes with pulse width modulation (PWM) dimming to control the intensity (brightness) of the display surface of the liquid crystal display device. That is, the conventional backlight device uses the PWM dimming that has a larger dimming range, namely a larger adjustable brightness range on the light-emitting surface than conventional current dimming, thereby providing a liquid crystal display device (television receiver) with an excellent display performance (brightness).

On the other hand, in the liquid crystal display device, as described in JP 2004-233932 A for example, the display image quality of dynamic images can be enhanced by inserting a black display signal, with which black display is carried out, into every other pixel of a predetermined horizontal display line, thereby providing a television receiver with an excellent display performance.

### DISCLOSURE OF INVENTION

### Problem to be Solved by the Invention

In the conventional backlight device as described above, however, all the cold-cathode tubes (linear light sources) are simultaneously turned on and off during on-time and off-time in the PWM dimming, respectively. Therefore, in the conventional backlight device, the on-time/off-time cycle (flashing cycle) of the PWM dimming of the cold-cathode tubes and a change in the brightness of display information to be displayed on the liquid crystal panel (display portion) interfere with each other, and in some cases the occurrence of nonuniform brightness or flickers in the display portion cannot be prevented. Particularly, in the conventional backlight device, when black display is carried out using the black display signal described in JP 2004-233932 A, the brightness of the pixels during the black display may change significantly with the on-time or off-time of the PWM making it difficult to prevent the nonuniform brightness or flickers from appearing prominently in the display portion.

With the forgoing in mind, it is an object of the present invention to provide a backlight device that can prevent the occurrence of nonuniform brightness and flickers even if the display performance is improved, and a display device and a television receiver that use the backlight device.

### Means for Solving Problem

In order to achieve the above object, a backlight device according to the present invention includes a linear light source and a light-emitting surface from which light of the linear light source is emitted toward the outside. The backlight device includes a light source unit that includes the linear light source and a driving circuit for driving the linear light source, and a control portion that receives a dimming indication signal to change the brightness of the light-emitting surface and controls the driving of the light source unit based on the input dimming indication signal. Furthermore, a plurality of light source units are provided in a direction perpendicular to a longitudinal direction of the linear light source, and the control portion turns on the linear light sources included in each of two light source units that are adjacent in the direction perpendicular to the longitudinal direction while the phases of on-time/off-time cycles of PWM dimming of the two adjacent light source units are shifted from each other.

In the backlight device with the above configuration, the control portion turns on the linear light sources in each of the light source units while the phases of on-time/off-time cycles of the PWM dimming of two light source units that are adjacent in the direction perpendicular to the longitudinal direction are shifted from each other. Unlike the above conventional example, this configuration can prevent the mutual interference between the on-time/off-time cycles of the PWM dimming and a change in the brightness of display information even if the display performance is improved, and also can prevent the occurrence of nonuniform brightness and flickers.

In the backlight device, it is preferable that the control portion includes a PWM dimming signal generator that determines an on/off duty ratio of the PWM dimming in accordance with the input dimming indication signal, generates a PWM dimming signal based on the on/off duty ratio thus determined, and outputs the PWM dimming signal to the driving circuit.

In this case, since the PWM dimming signal generator outputs the PWM dimming signal to the driving circuit, the amount of light from the linear light source can be increased or reduced in accordance with a request for a brightness change of the light-emitting surface, so that the brightness of the light-emitting surface can be changed appropriately.

In the backlight device, the control portion may turn on the linear light sources included in each of the two adjacent light source units while the phases of on-time/off-time cycles of the PWM dimming are shifted from each other by 180°.

In this case, the PWM dimming control does not have to be complicated even if three or more light source units are provided, and thus the configuration of the control portion can be simplified.

In the backlight device, the linear light source may be a pseudo U-shaped tube composed of a pair of straight-tube lamps each of which has a high-voltage electrode connected to the driving circuit and a low-voltage electrode located opposite the high-voltage electrode, and the pseudo U-shaped tube is configured by connecting the low-voltage electrodes with an external connection wiring.

In this case, a backlight device with the advantages of excellent utilization efficiency of light from the linear light source and a small number of components can be configured easily.

A display device of the present invention includes a display portion, and the display portion is irradiated with light from any of the above backlight devices.

In the display device with the above configuration, the display portion is irradiated with light the backlight device that can prevent the occurrence of nonuniform brightness and flickers even if the display performance is improved. Thus, a display device with an excellent display performance can be configured easily.

A television receiver of the present invention includes a display portion, and the display portion is irradiated with light from any of the above backlight devices.

In the television receiver with the above configuration, the display portion is irradiated with light from the backlight device that can prevent the occurrence of nonuniform brightness and flickers even if the display performance is improved. Thus, a television receiver with an excellent display performance can be configured easily.

### EFFECTS OF THE INVENTION

The present invention can provide a backlight device that can prevent the occurrence of nonuniform brightness and flickers even if the display performance is improved, and a display device and a television receiver that use the backlight device.

### BRIEF DESCRIPTION OF DRAWINGS

FIG. 1 is a schematic cross-sectional view illustrating a backlight device and a liquid crystal display device (television receiver) according to a first embodiment of the present invention.

FIG. 2 is a diagram illustrating a configuration of the main portions of the backlight device and the liquid crystal display device.

FIG. 3A is a diagram illustrating an example of a configuration of a CCFL driving circuit shown in FIG. 2, and FIG. 3B is a graph showing an example of an output waveform of a PWM dimming signal to the CCFL driving circuit.

FIG. 4 is a graph showing output waveforms of PWM dimming signals to each of the CCFL driving circuits in the backlight device shown in FIG. 2.

FIG. 5 is a plan view showing a lamp unit provided in a backlight device according to a second embodiment of the present invention.

FIG. 6 is a diagram illustrating a specific example of a configuration of a driving circuit of the lamp unit shown in FIG. 5.

### DESCRIPTION OF THE INVENTION

Hereinafter, preferred embodiments of the backlight device, the display device, and the television receiver of the present invention will be described with reference to the drawings. The following description gives an example of applying the present invention to a transmission type liquid crystal display device.

### First Embodiment

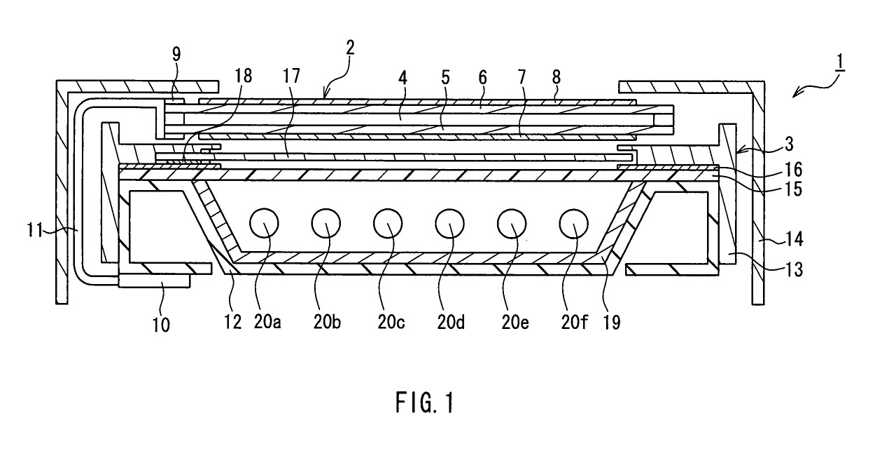

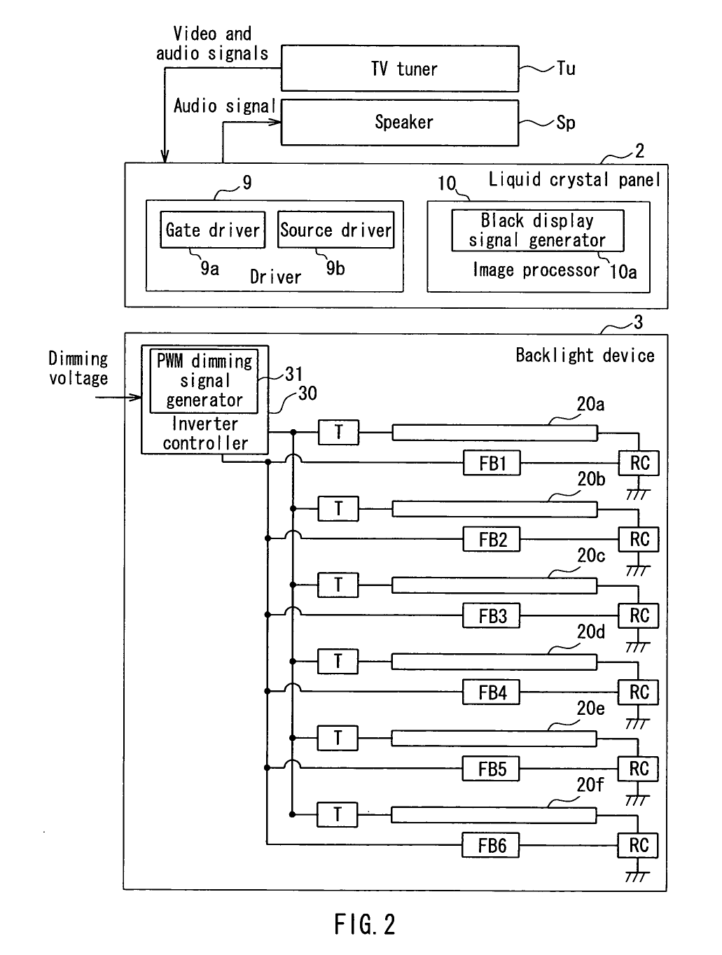

FIG. 1 is a schematic cross-sectional view illustrating a backlight device and a liquid crystal display device (television receiver) according to a first embodiment of the present invention. In FIG. 1, a liquid crystal display device 1 of this embodiment includes a liquid crystal panel 2 as a display portion that is placed so that the upper side of the figure is a viewer side (i.e., a display surface side), and a backlight device 3 of the present invention that is placed on a non-display surface side of the liquid crystal panel 2 (i.e., the lower side of the figure) and generates illumination light for illuminating the liquid crystal panel 2. In the liquid crystal display device 1, as shown in FIG. 2, a TV tuner Tu that receives video and audio signals of a television broadcast and a speaker Sp that reproduces and outputs audio signals are connected to the liquid crystal panel 2 side, and thus the liquid crystal display device 1 functions as a liquid crystal television.

The liquid crystal panel 2 includes a liquid crystal layer 4, a pair of transparent substrates 5, 6 sandwiching the liquid crystal layer 4, and polarizing plates 7, 8 provided on the outer surfaces of the transparent substrates 5, 6, respectively. The liquid crystal panel 2 also includes a driver 9 for driving the liquid crystal panel 2 and an image processor 10 connected to the driver 9 via a flexible printed board 11. The driver 9 includes a gate driver 9a and a source driver 9b connected respectively to a plurality of gate bus lines and a plurality of source bus lines that are arranged in matrix on the liquid crystal panel 2. The image processor 10 includes a black display signal generator 10a, and the display image quality of dynamic images or the like can be enhanced by appropriately displaying black on the liquid crystal panel 2 using a black display signal. In the liquid crystal panel 2, the polarization state of the illumination light incident through the polarizing plate 7 is modulated by the liquid crystal layer 4, and the amount of light passing through the polarizing plate 8 is controlled, thereby driving the liquid crystal layer 4 on the pixel basis to display a desired image.

The backlight device 3 includes a bottomed case 12 whose upper side in FIG. 1 (the liquid crystal panel 2 side) is opened, and a frame-shaped frame 13 set on the liquid crystal panel 2 side of the case 12. The case 12 and the frame 13 are made of metal or a synthetic resin and are interposed by a bezel 14 in an L-shape in cross-section while the liquid crystal panel 2 is set above the frame 13. In this manner, the backlight device 3 is combined with the liquid crystal panel 2 and is integrated therewith as the transmission type liquid crystal display device 1 in which the illumination light from the backlight device 3 enters the liquid crystal panel 2.

The backlight device 3 includes a diffusion plate 15 set so as to cover the opening of the case 12, an optical sheet 17 set above the diffusion plate 15 on the liquid crystal panel 2 side, and a reflection sheet 19 provided on an inner surface of the case 12. In the backlight device 3, a plurality of, for example, six cold-cathode tubes (CCFL) 20a, 20b, 20c, 20d, 20e, and 20f as linear light sources are arranged in parallel to each other above the reflection sheet 19. These cold-cathode tubes 20a to 20f are spaced uniformly at predetermined intervals (pitch) in a direction (the horizontal direction in FIG. 1) perpendicular to the longitudinal direction of the cold-cathode tubes, and light from each of the cold-cathode tubes 20a to 20f is emitted as the illumination light from the light-emitting surface of the backlight device 3 located opposite the liquid crystal panel 2.

The diffusion plate 15 is composed of, for example, a synthetic resin or a glass material in a rectangular shape with a thickness of about 2 mm, and diffuses light (including light reflected by the reflection sheet 19) from the cold-cathode tubes 20a to 20f and outputs it to the optical sheet 17 side. Furthermore, four sides of the diffusion plate 15 are mounted on a frame-shaped surface provided on the upper side of the case 12, and thus the diffusion plate 15 is incorporated in the backlight device 3 while being interposed between the frame-shaped surface of the case 12 and an inner surface of the frame 13 via a pressure member 16 that is deformable elastically. Furthermore, the diffusion plate 15 is supported by a transparent support member (not shown) whose substantially central portion is set on the reflection sheet 19, and is prevented from being bent toward an inner side of the case 12.

The diffusion plate 15 is held movably between the case 12 and the pressure member 16. Thus, even when the expansion/contraction (plastic) deformation of the diffusion plate 15 occurs due to the influence of heat caused by the heat generation of the cold-cathode tubes 20a to 20f and the increase in temperature inside of the case 12, the plastic deformation is absorbed by the elastic deformation of the pressure member 16, whereby the decrease in diffusion of light from the cold-cathode tubes 20a to 20f is minimized. It is preferred to use the diffusion plate 15 made of a glass material that is stronger with respect to heat compared with a synthetic resin since the warpage, yellowing, thermal deformation, and the like caused by the above influence of heat are unlikely to occur.

The optical sheet 17 includes a diffusion sheet composed of, for example, a synthetic resin film with a thickness of about 0.5 mm, and is configured so as to enhance the display quality on the display surface of the liquid crystal panel 2 by appropriately diffusing the illumination light to the liquid crystal panel 2. Furthermore, known optical sheet materials such as a prism sheet and a polarization sheet for enhancing the display quality on the display surface of the liquid crystal panel 2 may be laminated appropriately as needed. Then, the optical sheet 17 is configured so as to convert light output from the diffusion plate 15 into plane-shaped light having a predetermined brightness (e.g., 10000 cd/m²) or more and a uniform brightness and output the plane-shaped light to the liquid crystal panel 2 side as illumination light. Alternatively, an optical member such as a diffusion sheet for adjusting the viewing angle of the liquid crystal panel 2 may be laminated appropriately, for example, on the above (display surface side) of the liquid crystal panel 2.

In the optical sheet 17, for example, at the center on the left end side of FIG. 1 to be the upper side during the actual use of the liquid crystal display device 1, a protrusion protruding to the left side of the figure is formed. In the optical sheet 17, only the protrusion is interposed between the inner surface of the frame 13 and the pressure member 16 via an elastic material 18. The optical sheet 17 is incorporated in the backlight device 3 so as to expand/contract. Thus, in the optical sheet 17, even when expansion/contraction (plastic) deformation occurs due to the above influence of heat caused by the heat generation of the cold-cathode tubes 20a to 20f and the like, free expansion/contraction deformation can be performed mainly in the above protrusion, whereby the occurrence of wrinkles, bending, and the like in the optical sheet 17 can be minimized. Consequently, in the liquid crystal display device 1, the degradation in display quality, such as brightness nonuniformity, caused by the bending and the like of the optical sheet 17 can be minimized on the display surface of the liquid crystal panel 2.

The reflection sheet 19 is composed of, for example, a metal thin film such as aluminum or silver having a high light reflectance and a thickness of about 0.2 to 0.5 mm, and functions as a reflection plate that reflects light of the cold-cathode tubes 20a to 20f toward the diffusion plate 15. Thus, in the backlight device 3, light emitted from the cold-cathode tubes 20a to 20f can be reflected efficiently toward the diffusion plate 15, so that the light utilization efficiency and the brightness in the diffusion plate 15 can be enhanced. In addition to the above, a reflection sheet composed of a synthetic resin may be used in place of the metal thin film. Alternatively, the inner surface of the case 12 may function as a reflection plate, for example, by applying a coating with a high light reflectance such as a white coating to the inner surface.

A straight-tube fluorescent lamp type is used for each of the cold-cathode tubes 20a to 20f, and electrode portions (not shown) provided at both ends thereof are supported on an outer side of the case 12. Furthermore, a thinned tube having a diameter of about 3.0 to 4.0 mm and excellent light-emission efficiency also is used for each of the cold-cathode tubes 20a to 20f. Each of the cold-cathode tubes 20a to 20f is held inside the case 12 with a light source holder (not shown) while the distances from each of the cold-cathode tubes to the diffusion plate 15 and to the reflection sheet 19 are kept at predetermined distances. Furthermore, the cold-cathode tubes 20a to 20f are arranged so that the longitudinal direction thereof is parallel to a direction perpendicular to the direction of gravity. This arrangement can prevent mercury (vapor) sealed in each of the cold-cathode tubes 20a to 20f from being concentrated at one end of the cold-cathode tube in the longitudinal direction due to the action of gravity, resulting in significantly improved lamp life.

As shown in FIG. 2, the backlight device 3 includes an inverter controller 30 as a control portion for driving the cold-cathode tubes 20a to 20f with an inverter. That is, in the backlight device 3, a CCFL driving circuit T that serves as a driver is connected to one end of each of the cold-cathode tubes 20a to 20f. The CCFL driving circuits T are configured to drive the corresponding cold-cathode tubes 20a to 20f in response to the driving signals from the inverter controller 30. Furthermore, the backlight device 3 includes lamp current detectors RC provided for each of the cold-cathode tubes 20a to 20f to detect the value of a lamp current that has flowed through the corresponding cold-cathode tubes 20a to 20f. In the backlight device 3, the lamp current values detected by the lamp current detectors RC are output to the inverter controller 30 via feedback circuits FB1, FB2, FB3, FB4, FB5, and FB6 set in accordance with the cold-cathode tubes 20a to 20f. Thus, in the backlight device 3, feedback control is performed using the lamp current values detected in the respective cold-cathode tubes 20a to 20f, and each of the cold-cathode tubes 20a to 20f can be turned on at a target current value.

The cold-cathode tubes 20a to 20f and the CCFL driving circuits T, the lamp current detectors RC, and the feedback circuits FB1 to FB6 connected to the cold-cathode tubes 20a to 20f constitute light source units that are turned on independently of each other.

The inverter controller 30 is configured to control the driving of each of the light source units by PWM dimming. Specifically, the inverter controller 30 is configured so that the cold-cathode tubes 20a to 20f are turned on with their phases of on-time/off-time cycles of the PWM dimming being shifted from each other, as will be described in detail later. Furthermore, the inverter controller 30 includes a PWM dimming signal generator 31. When a dimming voltage that serves as a dimming indication signal for changing the brightness of the light-emitting surface of the backlight device 3 is externally input to the inverter controller 30, the PWM dimming signal generator 31 generates PWM dimming signals based on the input dimming voltage and outputs the PWM dimming signals as a driving signal to each of the CCFL driving circuits T. With this configuration, the liquid crystal display device 1 allows a user to appropriately change the brightness of the display surface of the liquid crystal panel 2.

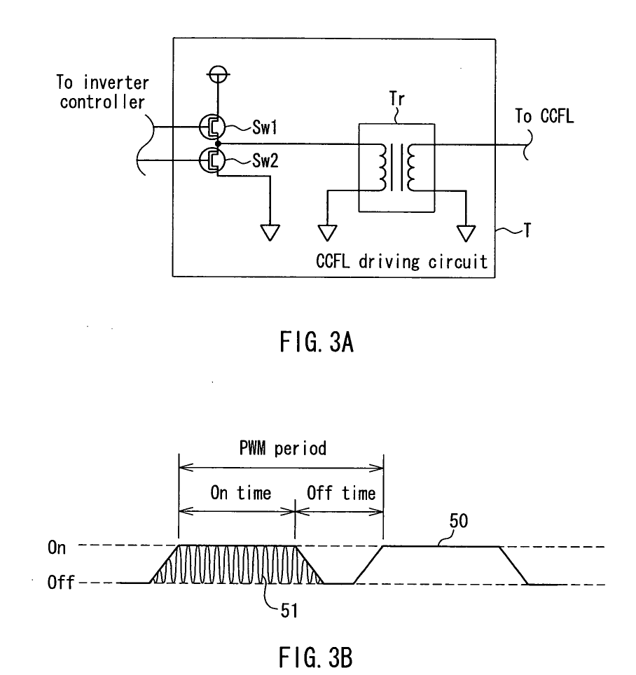

As shown in FIG. 3A, each of the CCFL driving circuits T includes an inverter circuit that includes a transformer Tr and transistors Sw1, Sw2 located on the primary winding side of the transformer Tr. The CCFL driving circuits T are designed to turn on the cold-cathode tubes 20a to 20f at high frequency. That is, a high-voltage terminal of any of the cold-cathode tubes 20a to 20f is connected to a secondary winding of the transformer Tr, and the transistors Sw1, Sw2 perform a switching operation based on the PWM dimming signal (driving signal) from the PWM dimming signal generator 31. Accordingly, the transformer Tr supplies power to the corresponding cold-cathode (20a to 20f) tube and turns on this cold-cathode tube.

Specifically, as shown in a waveform 50 in FIG. 3B, the PWM dimming signal generator 31 determines an on/off duty ratio of on-time to off-time of a PWM period of the PWM dimming in accordance with the dimming voltage. Then, the PWM dimming signal generator 31 generates PWM dimming signals based on the on/off duty ratio thus determined and outputs the PWM dimming signals to each of the CCFL driving circuits T. The specific frequency of the PWM dimming is a value (e.g., 200 Hz) in the range of about 100 to 600 Hz. Furthermore, a lamp current (shown in a waveform 51 in FIG. 3B) supplied to each of the cold-cathode tubes 20a to 20f, namely a specific operating frequency of each of the cold-cathode tubes 20a to 20f during the on-time of the PWM dimming is a value (e.g., 40 KHz) in the range of about 30 to 60 KHz.

At the time of transition from the off-time to the on-time of the PWM period, the signal is changed gradually from OFF to ON as shown in FIG. 3B, thereby preventing the occurrence of overshoot with respect to the target current value set to each of the cold-cathode tubes 20a to 20f. Thus, it is possible to prevent the generation of noise in the CCFL driving circuits T due to the overshoot.

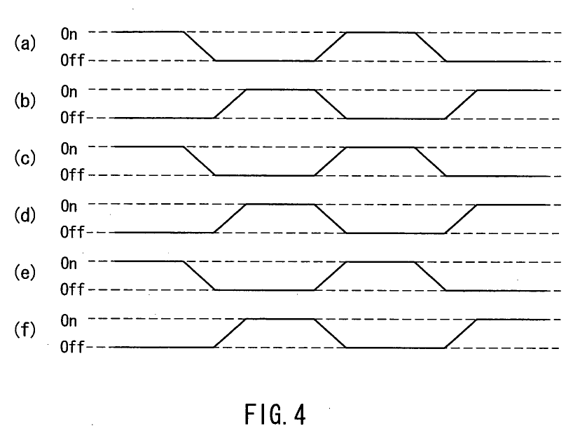

In the backlight device 3, as shown in FIGS. 4(a) to 4(f), the cold-cathode tubes 20a to 20f are turned on with their phases of on-time/off-time cycles of the PWM dimming being shifted from each other. More specifically, as shown in FIG. 4, the cold-cathode tubes 20a to 20f are powered and turned on while the phases of the PWM dimming of two cold-cathode tubes that are adjacent in the direction (i.e., the vertical direction in FIG. 4) perpendicular to the longitudinal direction are shifted from each other by 180°. This configuration can provide the effect comparable to that obtained by improving the frequency of the PWM dimming. Consequently, unlike the conventional example in JP 2000-292767 A in which all the cold-cathode tubes are turned on by PWM dimming with the same phase, the above configuration enables a user not to see the flashing of each of the cold-cathode tubes 20a to 20f on the light-emitting surface of the backlight device 3. In other words, the user can visually identify that all the cold-cathode tubes 20a to 20f are always turned on over the entire light-emitting surface of the backlight device 3.

As described above, in the backlight device 3 of this embodiment, the inverter controller (control portion) 30 turns on the cold-cathode tubes while the phases of on-time/off-time cycles of the PWM dimming of two cold-cathode tubes (linear light sources) that are adjacent in the direction perpendicular to the longitudinal direction are shifted from each other by 180°, thus making it visible that all the cold-cathode tubes 20a to 20f are always turned on. As a result, unlike the above conventional example, the backlight device 3 of this embodiment can prevent the mutual interference between the on-time/off-time cycle of the PWM dimming and a change in the brightness of display information even if the display performance is improved, and also can prevent the occurrence of nonuniform brightness and flickers.

### Second Embodiment

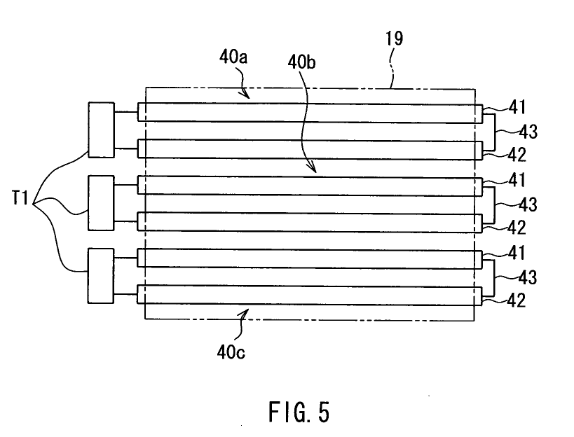

FIG. 5 is a plan view showing lamp units provided in a backlight device according to a second embodiment of the present invention. In FIG. 5, this embodiment mainly differs from the first embodiment in that the lamp units including a pseudo U-shaped tube are used in place of the light source units each of which includes a single cold-cathode tube and a CCFL driving circuit connected in series with the cold-cathode tube. The same components as those in the first embodiment are denoted by the same reference numerals, and the explanation will not be repeated.

As shown in FIG. 5; in the backlight device 3 of this embodiment, lamp units 40a, 40b, and 40c are set on a reflection sheet 19. Each of the lamp units 40a to 40c includes a pair of cold-cathode tubes 41, 42 and a connection wiring 43 for electrically connecting the pair of cold-cathode tubes 41, 42. In this configuration, a pseudo U-shaped tube is used to simulate a U-shaped tube. Furthermore, each of the lamp units 40a to 40c is provided with a driving circuit T1 that is connected to both the high-voltage sides of the cold-cathode tubes 41, 42 for driving each of the cold-cathode tubes 41, 42. In each of the lamp units 40a to 40c, the pseudo U-shaped tube is integrated with the driving circuit T1.

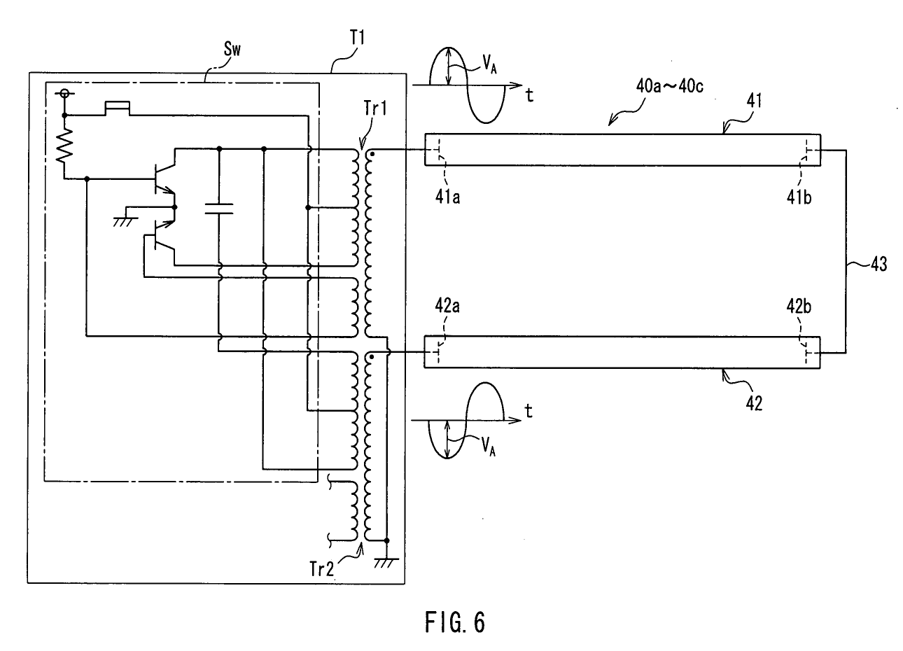

As shown in FIG. 6, the cold-cathode tubes 41, 42 include high-voltage electrodes 41a, 42a that are connected to the driving circuit T1 via connectors (not shown) and low-voltage electrodes 41b, 42b that are located opposite the high-voltage electrodes 41a, 42a. The low-voltage electrodes 41b, 42b are connected with the connection wiring 43 provided outside the lamp, so that the cold-cathode tubes 41, 42 are connected in series. Furthermore, the cold-cathode tubes 41, 42 are turned on at high frequency by lamp currents from the driving circuit T1, and the lamp currents having the same amplitude (VA) but opposite phases are synchronized and input to the high-voltage electrodes 41a, 42a.

Each of the driving circuits T1 includes identical first and second transformers Tr1, Tr2 for outputting the lamp currents to the cold-cathode tubes 41, 42, respectively and a control circuit Sw for controlling the driving of the transformers Tr1, Tr2. As shown in FIG. 6, the control circuit Sw includes a switching portion using two transistors, and electronic components such as a capacitor. An IC on which the electronic components are integrated is used for the control circuit Sw.

The inverter controller 30 (FIG. 2) is connected to each of the driving circuits T1 and controls the driving of the corresponding lamp units 40a to 40c by PWM dimming. Furthermore, similarly to the first embodiment, the cold-cathode tubes 41, 42 included in two pairs of lamp units 40a to 40c that are adjacent in the direction perpendicular to the longitudinal direction of the cold-cathode tubes are tuned on while the phases of on-time/off-time cycles of the PWM dimming of the two adjacent pairs of lamp units 40a to 40c are shifted from each other by 180°. As a result, similarly to the first embodiment, the backlight device 3 of this embodiment can prevent the mutual interference between the on-time/off-time cycle of the PWM dimming and a change in the brightness of display information even if the display performance is improved, and also can prevent the occurrence of nonuniform brightness and flickers.

Each of the above embodiments does not limit the present invention but is shown merely for illustrative purposes. The technical range of the present invention is defined by the scope of the claims, and all the modifications within the range equal to that of the configuration described in the claims also are included in the technical range of the present invention.

For example, in the above description, the present invention is applied to a transmission type liquid crystal display device. However, the backlight device of the present invention is not limited thereto and can be applied to a variety of display devices including a non-light-emitting display portion that displays information such as images, characters, etc. by using light of the linear light sources. Specifically, the backlight device of the present invention can be used preferably for a semi-transmission type liquid crystal display device or a projection type display device such as a rear projection type.

In the above description, the linear light sources included in each of two adjacent light source units are turned on while the phases of on-time/off-time cycles of the PWM dimming are shifted from each other by 180°. However, the present invention also can use a phase difference other than 180° as long as the linear light sources included in each of two light source units that are adjacent in the direction perpendicular to the longitudinal direction while the phases of on-time/off-time cycles of the PWM dimming of the two adjacent light source units are shifted from each other by 180°. Nevertheless, it is preferable that the phase difference of the on-time/off-time cycle is 180°, as described above, since the PWM dimming control does not have to be complicated even if three or more light source units are provided. Consequently, the configuration of the control portion can be simplified, and the cost can be reduced easily.

In the above description, although each of the light source units includes one or two cold-cathode tubes, the light source unit of the present invention may include any linear light sources, even three or more cold-cathode tubes, as long as they are connected in series with the driving circuit.

Furthermore, alternatively, the present invention can be used preferably as a film viewer irradiating light to a radiograph, a light box for irradiating light to a picture negative to make it easy to recognize the negative visually, and a backlight device of a light-emitting device that lights up a signboard, an advertisement set on a wall surface in a station or like.

In the above description, although the cold-cathode tube is used as a linear light source, the light source of the present invention is not limited thereto, and other linear light sources such as a hot cathode tube or xenon tube that is a mercury-less lamp also can be used. Furthermore, the present invention may use a linear light source in which a plurality of point light sources such as light-emitting diodes (LED) are arranged in line.

In the above description, the linear light sources are turned on regardless of video signals used in the liquid crystal panel. However, the present invention is not limited thereto, and signals such as a vertical synchronization signal included in the video signals can be reflected on the lighting operation of the linear light sources. Nevertheless, it is preferable that the linear light sources are turned on regardless of the video signals, as described in each of the above embodiments, since this can easily avoid complications of the lighting operation controlled by the control portion of the backlight device, and thus can suppress a significant increase in cost of the control portion.

In the above description, the driving circuit is connected to one end of the cold-cathode tube, and power is supplied from this end. However, the driving circuit may be connected to not only one end but also the other end of the cold-cathode tube, and power may be supplied from both ends of the cold-cathode tube.

In the above description of the second embodiment, a pair of straight-tube lamps formed as a pseudo U-shaped tube is used. However, the present invention is not limited thereto, and two straight tube portions of a U-shaped lamp may be used as a pair of straight-tube lamps.

Nevertheless, it is preferable to use the pseudo U-shaped tube as described above, since a straight-tube lamps with high light utilization efficiency and a simple structure can be configured easily compared with a U-shaped lamp.

### INDUSTRIAL APPLICABILITY

The backlight device of the present invention, and the display device and the television receiver that use the backlight device can prevent the occurrence of nonuniform brightness and flickers even if the display performance is improved. Therefore, the present invention is useful for a high-performance backlight device that can easily enhance the display quality, and a display device and a television receiver that use the backlight device.

1. A backlight device comprising:
a linear light source;
a light-emitting surface from which light of the linear light source is emitted toward an outside;
a light source unit that comprises the linear light source and a driving circuit for driving the liner light source; and
a control portion that receives a dimming indication signal to change brightness of the light-emitting surface and controls driving of the light source unit based on the input dimming indication signal,
wherein a plurality of light source units are provided in a direction perpendicular to a longitudinal direction of the linear light source, and
the control portion turns on the linear light sources included in each of two light source units that are adjacent in the direction perpendicular to the longitudinal direction while phases of on-time/off-time cycles of PWM dimming of the two adjacent light source units are shifted from each other.

2. The backlight device according to claim 1, wherein the control portion comprises a PWM dimming signal generator that determines an on/off duty ratio of the PWM dimming in accordance with the input dimming indication signal, generates a PWM dimming signal based on the on/off duty ratio thus determined, and outputs the PWM dimming signal to the driving circuit.

3. The backlight device according to claim 1, wherein the control portion turns on the linear light sources included in each of the two adjacent light source units while the phases of on-time/off-time cycles of the PWM dimming are shifted from each other by 180°.

4. The backlight device according to claim 1, wherein the linear light source is a pseudo U-shaped tube composed of a pair of straight-tube lamps each of which has a high-voltage electrode connected to the driving circuit and a low-voltage electrode located opposite the high-voltage electrode, and the pseudo U-shaped tube is configured by connecting the low-voltage electrodes with an external connection wiring.

5. A display device comprising a display portion,
wherein the display portion is irradiated with light from the backlight device according to claim 1.

6. A television receiver comprising a display portion,
wherein the display portion is irradiated with light from the backlight device according to claim 1.

7. The backlight device according to claim 2, wherein the control portion turns on the linear light sources included in each of the two adjacent light source units while the phases of on-time/off-time cycles of the PWM dimming are shifted from each other by 180°.

8. The backlight device according to claim 2, wherein the linear light source is a pseudo U-shaped tube composed of a pair of straight-tube lamps each of which has a high-voltage electrode connected to the driving circuit and a low-voltage electrode located opposite the high-voltage electrode, and the pseudo U-shaped tube is configured by connecting the low-voltage electrodes with an external connection wiring.

9. The backlight device according to claim 3, wherein the linear light source is a pseudo U-shaped tube composed of a pair of straight-tube lamps each of which has a high-voltage electrode connected to the driving circuit and a low-voltage electrode located opposite the high-voltage electrode, and the pseudo U-shaped tube is configured by connecting the low-voltage electrodes with an external connection wiring.

10. A display device comprising a display portion,
wherein the display portion is irradiated with light from the backlight device according to claim 2.

11. A display device comprising a display portion,
wherein the display portion is irradiated with light from the backlight device according to claim 3.

12. A display device comprising a display portion,
wherein the display portion is irradiated with light from the backlight device according to claim 4.

13. A television receiver comprising a display portion,
wherein the display portion is irradiated with light from the backlight device according to claim 2.

14. A television receiver comprising a display portion,
wherein the display portion is irradiated with light from the backlight device according to claim 3.

15. A television receiver comprising a display portion,
wherein the display portion is irradiated with light from the backlight device according to claim 4.

16. A television receiver comprising a display portion,
wherein the display portion is irradiated with light from the backlight device according to claim 5.
